(19) United States
(12) Patent Application Publication
(10) Pub. No.: US 2014/0178793 A1
(43) Pub. Date: Jun. 26, 2014

(54) SOLID OXIDE FUEL CELL

(71) Applicant: SAMSUNG ELECTRO-MECHANICS CO., LTD., (US)

(72) Inventors: Jong Ho Chung, Suwon (KR); Sung Han Kim, Suwon (KR); Jong Sik Yoon, Suwon (KR); Bon Seok Koo, Suwon (KR)

(73) Assignee: SAMSUNG ELECTRO-MECHANICS CO., LTD., Suwon (KR)

(21) Appl. No.: 13/844,264

(22) Filed: Mar. 15, 2013

(30) Foreign Application Priority Data
Dec. 24, 2012 (KR) 10-2012-0152088

(51) Int. Cl. H01M 8/10

(52) U.S. Cl. CPC H01M 8/1006
USPC 429/482

(57) ABSTRACT

Disclosed herein is a unit cell including: an internal electrode including a flat upper surface and a lower surface arranged in parallel to face each other and a plurality of internal channels having a flat lower side disposed between the upper surface and the lower surface; an interconnector seated on the upper surface of the internal electrode; an electrolyte laminated on an outer circumferential surface of the internal electrode, except for the interconnector; and an external electrode laminated on an outer circumferential surface of the electrolyte.

### CROSS REFERENCE TO RELATED APPLICATION

This application claims the benefit of Korean Patent Application No. 10-2012-0152088, filed on Dec. 24, 2012, entitled “Solid Oxide Fuel Cell” which is hereby incorporated by reference in its entirety into this application.

### BACKGROUND OF THE INVENTION

1. Technical Field

The present invention relates to a solid oxide fuel cell, and more particularly, to a flat tubular solid oxide fuel cell.

2. Description of the Related Art

A fuel cell is an apparatus that directly converts chemical energy of fuel (hydrogen, LNG, LPG, or the like) and air (oxygen) into electricity and heat by an electrochemical reaction. Power generation technologies according to the prior art need to perform processes such as fuel combustion, vapor generation, turbine driving, generator driving, or the like. On the other hand, the fuel cell is a new conceptual power generation technology that increases high efficiency but does not induce environmental problems since the fuel cell does not have to include a combustion process or a driving apparatus. The fuel cell little emits air pollutants such as SOₓ, NOₓ, or the like, can achieve pollution-free power generation due to the reduced generation of carbon dioxide, and can achieve low noise, non-vibration, or the like.

As the fuel cell, there are various types of fuel cells such as a phosphoric acid fuel cell (PAFC), an alkaline fuel cell (AFC), a polymer electrolyte type fuel cell (PEMFC), a direct methanol fuel cell (DMFC), a solid oxide fuel cell (SOFC), or the like. Among others, the solid oxide fuel cell (SOFC) is based on activation polarization to prevent overvoltage and reduce an irreversible loss, thereby increasing power generation efficiency. Further, the solid oxide fuel cell may use hydrogen as well as carbon or hybrid-based fuel as fuel, and has a wide selection of fuel and a high reaction rate, such that the solid oxide fuel cell does not have to use expensive precious metals as an electrode catalyst. In addition, the solid oxide fuel cell is of a high utility value since heat incidentally emitted during power generation is very high temperature. The heat generated from the solid oxide fuel cell is used for a reform of fuel as well as may be used as an industrial or cooling energy source in cogeneration power generation. Therefore, the solid oxide fuel cell is a power generation technology that is essential to enter hydrogen economy in the future.

Describing a basic operation principle of the solid oxide fuel cell, the solid oxide fuel cell is basically an apparatus of generating electricity by oxidation reaction of hydrogen and CO and includes an anode and a cathode in which electrode reaction dependent on the following Chemical Formula 1 happens.

Anode reaction: H₂+O₂→H₂O+2e⁻CO+O₂⁻→CO₂+2e⁻

Cathode reaction: O₂+4e⁻→2O₂⁻

Overall reaction: H₂+CO+O₂→H₂O+CO₂ [Chemical Formula 1]

That is, electrons are delivered to the cathode via an external circuit and oxygen generated from the cathode is delivered to the anode via an electrolyte, such that hydrogen or carbon monoxide (CO) is combined with oxygen ions in the anode to generate electrons, water, or carbon dioxide (CO₂).

The solid oxide fuel cell according to the prior art, in particular, the flat tubular SOFC provides a channel for reaction gas (fuel gas or air) in a unit cell as described in Patent Document 1.

The channel is used as a path through which the reaction gas may cross the inside of the cell. Patent Document 1 adopts a general oval channel that has been widely used in the flat tubular solid oxide fuel cell according to the prior art.

The oval (or circular) channel has an increased channel sectional area to maximize a flow rate of reaction gas flowing therein, which has been widely used by a person having ordinary skill in the art to which the present invention pertains. However, the channel according to the prior art has a limitation designed not to consider a moving direction of current.

Therefore, the solid oxide fuel cell may overcome problems regarding the easiness of gas permeation and the reduction in a moving path of current by making a thickness of a unit cell, in more to detail, a thickness of a support for an internal electrode maximally thin. However, the unit cell may have vulnerability in terms of mechanical stability of the support.

### PRIOR ART DOCUMENT

### Patent Document

(Patent Document 1) Patent Document 1: JP Patent Laid-Open Publication No. 2010-10071

### SUMMARY OF THE INVENTION

The present invention has been made in an effort to improve mechanical stability of a unit cell and a reaction rate of an internal electrode by improving a section shape of a channel formed in a unit cell.

According to a preferred embodiment of the present invention, there is provided a solid oxide fuel cell including a unit cell, including: an internal electrode including a flat upper surface and a lower surface arranged in parallel to face each other and a plurality of internal channels having a flat lower side disposed between the upper surface and the lower surface; an interconnector seated on the upper surface of the internal electrode; an electrolyte laminated on an outer circumferential surface of the internal electrode, except for the interconnector; and an external electrode laminated on an outer circumferential surface of the electrolyte.

The internal channel may have a pair of upper side and lower side arranged in parallel to face each other and have a trapezoidal section shape.

The upper side of the internal channel may be arranged to face the interconnector.

length of the lower side may be longer than that of the upper side.

A thickness of the internal electrode may be formed to be larger than a height of the internal channel.

The internal channel may have a triangular section shape having a flat lower side.

A thickness of the internal electrode may be formed to be larger than a height of the internal channel.

The internal channel may have a semi-circular section shape having a flat lower side.

The lower side may be a lower side of the internal channel having the semi-circular section shape.

A thickness of the internal electrode may be formed to be larger than a radius of the internal channel.

The unit cell may include a flat tubular anode, an electrolyte on an outer circumferential surface of the anode, and a cathode that are laminated in order, wherein the anode forms the internal electrode and the cathode forms the external electrode.

The unit cell may include a flat tubular cathode, an electrolyte on an outer circumferential surface of the cathode, and an anode that are laminated in order, wherein the cathode forms the internal electrode, and the anode forms the external electrode.

The internal electrode may have a gap between the lower surface and the lower side of the internal channel narrower than a gap between the upper surface and the upper side of the internal channel.

The lower side of the internal channel and the lower surface of the internal electrode may be arranged in parallel to face each other.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a cross-sectional view of a solid oxide fuel cell according to a first preferred embodiment of the present invention;

FIG. 2 is a cross-sectional view of a solid oxide fuel cell according to a second preferred embodiment of the present invention; and

FIG. 3 is a cross-sectional view of a solid oxide fuel cell according to a third preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, a solid oxide fuel cell according to the present invention will be described in detail with reference to the accompanying drawings.

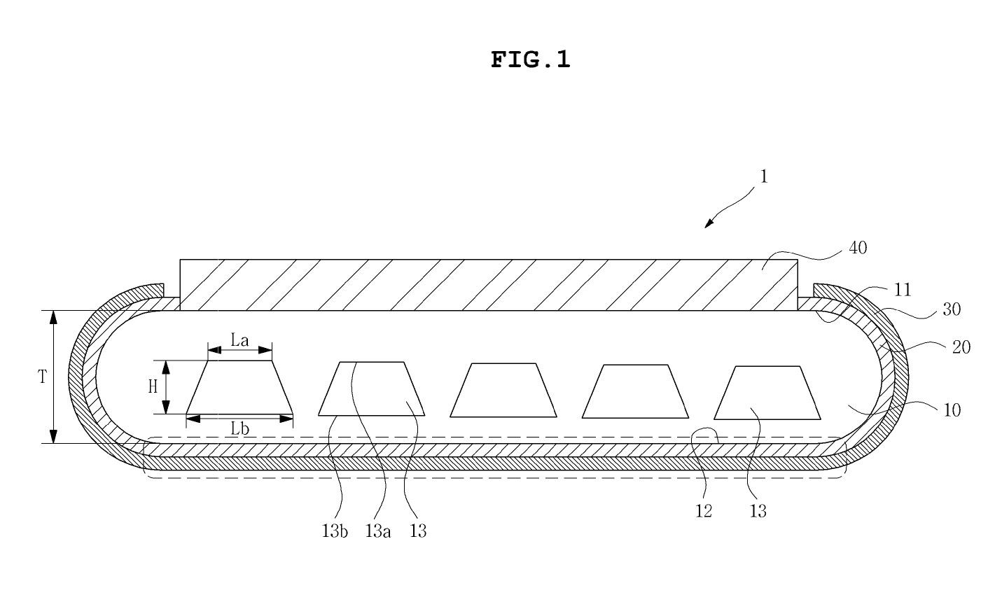

FIG. 1 is a cross-sectional view of a solid oxide fuel cell according to a first preferred embodiment of the present invention.

The present invention relates to a solid oxide fuel cell, and more particularly, to a flat tubular solid oxide fuel cell.

The solid oxide fuel cell according to the first preferred embodiment of the present invention is configured of a flat tubular unit cell 1 as illustrated in FIG. 1, which includes an internal electrode 10, an electrolyte 20, an external electrode 30, and an interconnector 40 formed on a portion on an outer circumferential surface of the internal electrode 10, all of which have been known in advance. The interconnector 40 is spaced apart from the external electrode 30 at a predetermined distance. Selectively, the interconnector 40 is protruded from an upper surface 11 of the internal electrode 10 to the outside but is protruded more than the top end of the external electrode 30. This helps the interconnector 40 to connect with another current collector or a current collector plate.

In detail, the unit cell 1 may be laminated in an order of the internal electrode 10, the electrolyte 20 disposed on the outer circumferential surface of the internal electrode 10, and the external electrode 30 disposed on an outer circumferential surface of the electrolyte 20 from an inner side thereof. As an example of the unit cell 1, an anode (internal electrode), the electrolyte, and a cathode (external electrode) may be laminated or as another example, the cathode (internal electrode), the electrolyte, and the anode (external electrode) may be laminated.

In the present specification, a solid oxide fuel cell adopting the unit cell 1 of an anode support type using the anode as the internal electrode will be described. Further, unlike the present embodiment, when the unit cell using the cathode as the internal electrode is adopted, it is revealed beforehand that the unit cell 100 in which only a configuration of a moving path of fuel and air is substituted may be used.

The internal electrode 10 may be supplied with reaction gas through an internal channel 13 of the internal electrode 10 to lead to electrode reaction, while supporting the electrolyte 20 and the external electrode 30 to be laminated on the outer circumferential surface thereof. In detail, the internal electrode 10 formed as the anode support is supplied with fuel (hydrogen) from a manifold to generate negative current by the electrode reaction.

Preferably, the anode is formed by heating nickel oxide (NiO) and yttria stabilized zirconia (YSZ) from 1,200° C. to 1,300° C. In this case, the nickel oxide is reduced to metal nickel by hydrogen to exhibit electronic conductivity and the yttria stabilized zirconia that is oxide exhibits ion conductivity as oxide.

The electrolyte 20 helps to deliver oxygen ions generated from the cathode to the anode and as illustrated in FIG. 1, is laminated on the outer circumferential surface of the internal electrode 10.

The electrolyte 20 may be formed by being coated by dry methods, such as plasma spray, electrochemical deposition, sputtering, ion beam, and ion injection or wet methods, such as tape casting, spray coating, dip coating, screen printing, and doctor blade, all of which have been widely known to a person having ordinary skill in the art to which the present invention pertains and then sintered at 1,300° C. to 1,500° C. The electrolyte 20 is formed on the outside of the anode using YSZ or scandium stabilized zirconia (ScSZ), GDC, LDC, and the like. In this case, the yttria stabilized zirconia has one oxygen ion hole per two yttrium ions generated therein since a part of tetravalence zirconium ions is substituted into trivalence yttrium ion such that oxygen ions move through the hole at high temperature. Meanwhile, since the electrolyte 20 has low ion conductivity and generates low voltage drop due to resistance polarization, the electrolyte 20 is preferably formed as thinly as possible. When voids are generated in the electrolyte 20, a cross over phenomenon in which fuel (hydrogen) directly reacts with air (oxygen) is generated, and thus the efficiency may be degraded. As a result, it is careful not to generate flaws in the electrolyte 20.

The external electrode 30 used as the cathode is supplied with air (oxygen) from the outside under the oxidizing atmosphere to lead to the electrode reaction, which generates positive current and is laminated on the outer circumferential surface of the electrolyte 20 as illustrated. The cathode may be formed by coating lanthanum strontium manganite (La_{0.84}Sr _{0.16}) MnO₃), and the like, having high electronic conductivity by the wet methods or the dry method similar to the electrolyte and sintering it at 1,200° C. to 1,300° C. That is, air (oxygen) is converted into oxygen ion by a catalytic action of the lanthanum strontium manganite in the cathode, which is in turn delivered to the internal electrode 10 that is an anode support via the electrolyte 20.

As illustrated, the interconnector 40 is directly connected with a portion on the outer circumferential surface of the internal electrode 10 to deliver negative current generated in the anode of the internal electrode 10 to the outside of the unit cell 1 (or current collector plate). In other words, the interconnector 40 is a member for current collection of the internal electrode 10, and therefore needs to have electrical conductivity.

As known to a person having ordinary skill in the art to which the present invention pertains, the unit cell 1 moves reaction gas (fuel gas and air) to the internal electrode 10 and the external electrode 30, respectively, centered on the electrolyte 20. When one reaction gas flowing in the internal channel 13 of the internal electrode 10 contacts the other reaction gas flowing in the outside of the external electrode 30 due to a partial pressure difference of the unit cell 1, the unit cell 1 may be ignited unexpectedly and the durability of the solid oxide fuel cell may be weakened.

In particular, the solid oxide fuel cell according to the first preferred embodiment of the present invention includes the unit cell 1 having at least one internal channel 13 with a trapezoidal section shape so as to uniformly diffuse the reaction gas such as fuel supplied to the internal channel 13. As illustrated, the internal electrode 10 has a flat tubular shape and includes the upper surface 11 and a lower surface 12 arranged in parallel to face each other. A distance between the upper surface 11 and the lower surface is referred to as a thickness T and the internal electrode 10 is filled with porous materials, except for the plurality of internal channels 13.

In detail, the internal electrode 10 includes the internal channel 13 with a trapezoidal section shape having a pair of upper side 13a and lower side 13b arranged in parallel so as to face each other. Here, a height H means a distance between the upper side 13a and the lower side 13b of the internal channel 13. Preferably, the height H of the internal channel 13 needs to be set smaller than the thickness T of the internal electrode 10. In addition, the internal channels 13 are spaced from each other at equidistance to help to uniformly diffuse gas in the internal electrode 10 to improve the performance of the unit cell 1.

As illustrated, the interconnector 40 is seated on the exposed upper surface 11 of the internal electrode 10 to be electrically connected, but may be arranged to face the upper side 13a of the internal channel 13.

In addition to this, the lower surface 12 of the internal electrode 10 is adjacently arranged to the lower side 13b of the internal channel 13. In the unit cell 1, the overall electrode reaction of the internal electrode 10 may mainly happen between the lower surface of the internal channel 13 and the lower surface 12 of the internal electrode 10.

In the solid oxide fuel cell according to the first preferred embodiment of the present invention, the lower side 13b of the internal channel 13 and the lower surface 12 of the internal electrode 10 are arranged in parallel so that the reaction gas may be uniformly supplied over the main reaction region (in detail, an interval between the lower side 13b and the lower surface 12) marked by a dotted line at which the overall electrode reaction happens. In particular, a length L_{b} of the lower side 13b is formed to be longer than a length Lₐ of the upper side 13a, thereby maximizing the contact area with the main reaction region. A total length L_{b} of the lower side 13b formed in the internal electrode 10 is increased, such that an effective area for a flow of current is maximized in the main reaction region and a flow of current is improved, thereby improving power density.

Further, the unit cell 1 of the preferred embodiment of the present invention has a gap between the lower surface 12 and the lower side 13b narrower than a gap between the upper surface 11 and the upper side 13a to reduce a permeable distance of gas crossing the lower side 13b and the lower surface 12 arranged in parallel as described above so as to concentrate the electrode reaction in the reaction region, thereby improving the power density. The oxygen ion generated in the cathode, the external electrode 30 is delivered to the internal electrode 10 that is the anode via the electrolyte 20. In this case, a spaced distance between the lower side 13b and the lower surface 12 of the internal channel 13 is narrower than a spaced distance between the upper side 13a and the upper surface 11 (a portion at which the interconnector 40 is arranged), thereby more activating the electrode reaction. For example, when the reaction gas guided to the internal channel 13 is supplied to the internal electrode 10 by crossing the upper side 13a, the oxygen ion generated in the external electrode 30 is introduced into the internal electrode 10 through the electrolyte 20 and the interconnector 40 is disposed on the upper side 13a, such that the permeable distance for coupling with the oxygen ion delivered through the other surface (including the lower surface 12) except for the upper surface 11 of the internal electrode 10 is long, thereby remarkably reducing the power density in the regions other than in the main reaction region.

Based on the fact, the unit cell is designed so that the electrode reaction in the internal electrode 10 is concentrated in the main reaction region marked by an arc, such that the porosity of the internal electrode 10 may be more reduced than that of the internal electrode according to the prior art. As a result, the unit cell 1 may adopt the internal electrode 10 having low porosity, thereby improving the mechanical strength of the internal electrode 10.

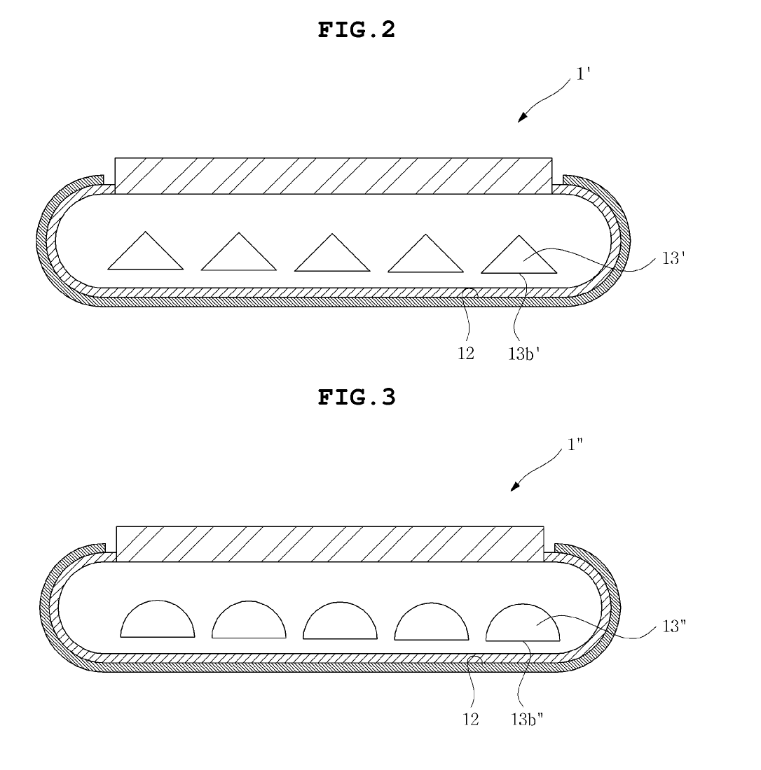

FIG. 2 is a cross-sectional view of a solid oxide fuel cell according to a second preferred embodiment of the present invention.

A flat tubular unit cell 1′ illustrated in FIG. 2 has a very similar structure to the flat tubular unit cell 1 illustrated in FIG. 1, except for the section shape of the internal channel 13 of the flat tubular unit cell 1, and therefore the description of like or same components will not be made herein to help the clear understanding of the present invention.

As illustrated, the solid oxide fuel cell according to the second preferred embodiment of the present invention includes the unit cell 1′ having an internal channel 13′ with a triangular section shape so as to uniformly diffuse reaction gas supplied to the internal channel 13′, for example, a fuel.

As described above, the internal channel 13′ has a triangular section shape, such that a lower side 13b′ of the internal channel 13′ and the lower surface 12 of the internal electrode 10 may be arranged in parallel. The lower side 13b′ and the lower surface 12 are adjacently disposed to each other in the reaction region between the lower side 13b′ and the lower surface 12, thereby maximizing the effective area and concentrating the power density in the reaction region.

FIG. 3 is a cross-sectional view of a solid oxide fuel cell according to a third preferred embodiment of the present invention.

A flat tubular unit cell 1″ illustrated in FIG. 3 has a very similar structure to the flat tubular unit cell illustrated in FIGS. 1 and 2, except for the section shape of the internal channel of the flat tubular unit cell, and therefore the description of like or same components will not be made herein to help the clear understanding of the present invention.

As illustrated, the solid oxide fuel cell according to the third preferred embodiment of the present invention includes the unit cell 1″ having an internal channel 13″ with a semi-circular section shape so as to uniformly diffuse reaction gas supplied to the internal channel 13″, for example, a fuel.

As described above, the internal channel 13″ has a semi-circular shape, such that a lower side 13b″ (corresponding to a diameter) of the internal channel 13″ and the lower surface 12 of the internal electrode 10 may be arranged in parallel. The lower side 13b″ and the lower surface 12 are adjacently disposed to each other in the reaction region between the lower side 13b″ and the lower surface 12, thereby maximizing the effective area and concentrating the power density in the reaction region.

As set forth above, according to the preferred embodiment of the present invention, the solid oxide fuel cell designed to minimize the gas permeable path into the main reaction region of the unit cell can be provided.

Further, according to the preferred embodiment of the present invention, it is possible to reduce the gas permeable path and improve the reaction rate of the electrode by having one surface of the channel very closely disposed to the main reaction region of the unit cell.

In particular, the preferred embodiment of the present invention can improve the reduction in the permeable path between the main reaction region and the channel and the contact area, thereby adopting the internal electrode having low porosity. As a result, it is possible to improve the mechanical strength of the internal electrode.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A solid oxide fuel cell including a unit cell, comprising:
an internal electrode including a flat upper surface and a lower surface arranged in parallel to face each other and a plurality of internal channels having a flat lower side disposed between the upper surface and the lower surface;
an interconnector seated on the upper surface of the internal electrode;
an electrolyte laminated on an outer circumferential surface of the internal electrode, except for the interconnector; and
an external electrode laminated on an outer circumferential surface of the electrolyte.

2. The solid oxide fuel cell as set forth in claim 1, wherein the internal channel has a pair of upper side and lower side arranged in parallel to face each other and has a trapezoidal section shape.

3. The solid oxide fuel cell as set forth in claim 2, wherein the upper side of the internal channel is arranged to face the interconnector.

4. The solid oxide fuel cell as set forth in claim 2, wherein a length of the lower side is longer than that of the upper side.

5. The solid oxide fuel cell as set forth in claim 2, wherein a thickness of the internal electrode is formed to be larger than a height of the internal channel.

6. The solid oxide fuel cell as set forth in claim 1, wherein the internal channel has a triangular section shape having a flat lower side.

7. The solid oxide fuel cell as set forth in claim 6, wherein a thickness of the internal electrode is formed to be larger than a height of the internal channel.

8. The solid oxide fuel cell as set forth in claim 1, wherein the internal channel has a semi-circular section shape having a flat lower side.

9. The solid oxide fuel cell as set forth in claim 8, wherein the lower side is a lower side of the internal channel having the semi-circular section shape.

10. The solid oxide fuel cell as set forth in claim 8, wherein a thickness of the internal electrode is formed to be larger than a radius of the internal channel.

11. The solid oxide fuel cell as set forth in claim 1, wherein the unit cell includes a flat tubular anode, an electrolyte on an outer circumferential surface of the anode, and a cathode that are laminated in order, the anode forming the internal electrode and the cathode forming the external electrode.

12. The solid oxide fuel cell as set forth in claim 1, wherein the unit cell includes a flat tubular cathode, an electrolyte on an outer circumferential surface of the cathode, and an anode that are laminated in order, the cathode forming the internal electrode and the anode forming the external electrode.

13. The solid oxide fuel cell as set forth in claim 1, wherein the internal electrode has a gap between the lower surface and the lower side of the internal channel narrower than a gap between the upper surface and the upper side of the internal channel.

14. The solid oxide fuel cell as set forth in claim 1, wherein the lower side of the internal channel and the lower surface of the internal electrode are arranged in parallel to face each other.
